(19) United States
(12) Patent Application Publication
(10) Pub. No.: US 2026/0327411 A1
(43) Pub. Date: Oct. 22, 2026

(54) AQUEOUS SALT-FREE STABLE FLUID SUSPENSION COMPOSITIONS AND A METHOD OF PREPARATION THEREOF

(71) Applicant: HERCULES LLC, Wilmington, DE (US)

(72) Inventors: Joachim KRAUSE, Remscheid (DE); Michael DITTEL, Duesseldorf (DE)

(73) Assignee: HERCULES LLC, Wilmington, DE (US)

(21) Appl. No.: 19/100,505

(22) PCT Filed: Jul. 25, 2023
(86) PCT No.: PCT/US2023/070935

§ 371 Date: Jan. 31, 2025

Related U.S. Application Data
(60) Provisional application No. 63/394,231, filed on Aug. 1, 2022.

(51) Int. Cl. C08L 1/28; C08K 3/30; C08K 5/053; C08K 5/092; C08K 5/098; C08K 5/1545; C08K 5/47

(52) U.S. Cl. CPC C08L 1/28; C08K 3/30; C08K 5/053; C08K 5/092; C08K 5/098; C08K 5/1545; C08K 5/47; C08K 2003/3054

(57) ABSTRACT

Present application relates to an aqueous based, salt-free, stable fluid suspension composition comprising: (i) about 0.01 wt. % to about 30 wt. % of at least one cellulose ether, (ii) about 0.01 wt. % to about 90 wt. % of at least one insolubilizing agent selected from the group consisting of monosaccharide, disaccharide, polysaccharide, inverted sugar, and combinations thereof, (iii) about 0.01 wt. % to about 5 wt. % of at least one stabilizing agent, (iv) about 0.01 wt. % to about 5 wt. % of at least one preservative, and (v) about 0.01 wt. % to about 70 wt. % of water.

### FIELD OF THE INVENTION

This invention relates to the stable fluid suspension compositions and particularly, relates to an aqueous based, salt-free, stable fluid suspension composition comprising at least one cellulose ether and at least one salt-free insolubilizing agent.

### BACKGROUND OF THE INVENTION

Cellulose ether polymers are the most commonly used rheology modifiers in aqueous based formulations. It is generally supplied in the powder form, which are then subsequently dissolved into various water-based systems to achieve desired rheology profiles. Processing difficulties were encountered while incorporating and dispersing said cellulosic ether powders into water-containing liquid formulations and often tend to form lumps when added to water-based systems. When the water soluble polymer powder is added in bulk, particles at the interface between powder phase and fluid phase of such water-based systems begin to rapidly hydrate and swell and causes particle jamming at the interface and slows down fluid penetration into the interior of the powder phase. This process ultimately results in the formation of persistent, slowly dissolving gel agglomerates of various sizes and adversely affect the rate of dissolution.

A number of approaches have been used in the prior-arts for producing lump free dissolution of water soluble polymers. Commonly-used approaches are (a) slow addition of water soluble polymer powder, (b) pre-wetting of the water soluble polymer powders with water miscible solvent, and (c) blending the water soluble polymer powder with other dry material prior to utilization. Each of the above mentioned approaches has a downside. For example, approach (a) greatly slows down powder utilization, approaches (b) and (c) may carry over substantial concentrations of additives which may have negative effects on the product to which the water soluble polymer product was added, either from an environmental compliance or from a performance standpoint.

Other known approaches to overcome the issues of lump formation with water soluble polymers during solution preparation are (i) using glyoxal retarded cellulose ether, (ii) pre-dispersing the cellulose ether using an organic liquid or, (iii) dispersing in water which is heated over the flocculation point (hot-cold method). The problem with glyoxal treated retarded cellulose ether is that, if the liquid carrier is acidic, the retardation gets prolonged, and on the other hand, if the solution will be too alkaline the retardation is not efficient enough. Pre-dispersing with organic liquids introduces chances of VOC content; the hot-cold method is very energy intensive and only suitable for products with flocculation points below the boiling point of water.

Use of fluidized polymer suspensions of the cellulose ether polymer powders offered better results and proved effective to overcome aforesaid process difficulties. This method also eliminated the formation of dust when introducing powdery or granular cellulose ethers into a water-based product formulation and additionally offered benefits such as accurate dosing, improved measurability, and handling of the powdered cellulose ether ingredients. It also facilitates quick distribution of the powdered cellulose ether in the water-based product formulations, without any lump formation.

U.S. Pat. No. 4,469,627 filed by Colgate Palmolive Co, discloses a process for dispersing hydroxypropyl methyl cellulose in a nonaqueous liquified organic medium in which it does not swell or dissolve, and subsequently adding said dispersion to an aqueous-containing liquid formulation wherein it is readily solubilized.

U.S. Pat. No. 4,883,536 filed by Aqualon discloses fluid polymer suspensions of cellulosic polymers using ammonium salts having multivalent anions.

U.S. Pat. No. 4,283,229 filed by Hoechst AG discloses, a process for the preparation of a stable aqueous cellulose ether suspension which contains an electrolyte, and to the use of such a suspension.

U.S. Pat. No. 4,883,537 filed by Aqualon discloses stable aqueous suspensions of water-soluble carboxymethylcellulose, a process for preparing the same, and use of the same in a variety of applications.

U.S. Pat. No. 6,025,311 filed by Aqualon discloses the use of aqueous fluid suspensions of polysaccharides in cosmetic, personal care and household applications.

U.S. Pat. Nos. 6,576,048; 6,433,056; 5,268,466; and U.S. Pat. No. 5,228,909 filed by Hercules/Aqualon are yet another list of prior-art documents that particularly teach the use of cellulose ether polymers and salts in fluidized polymer suspension compositions.

In order to prepare a stable fluid polymer suspension composition, it is essential to restrict the swelling behavior of hydrophilic cellulose ether polymers in the aqueous medium. This may be achieved using several approaches that may effectively reduce the solvating power of the aqueous carrier. Methods described in the prior-art involve addition of inorganic salt compounds and a wide variety of inorganic salts have been found useful for this purpose, which may include sodium chloride, potassium chloride, sodium citrate, sodium sulfate, sodium formate, potassium phosphate, calcium formate, potassium formate, sodium acetate, potassium bicarbonate, sodium bicarbonate, diammonium phosphate, ammonium sulfate, etc. The concentration of inorganic salts must be adjusted such that the flocculation (or cloud) point, i.e., the temperature at which a polymer precipitates or gels from solution to render a cloudy dispersion, is below room temperature. The concentration of inorganic salts in the fluid polymer suspension must be sufficiently high to render the hydrophilic cellulose ether polymer insoluble in the salt water in a temperature at which the fluid polymer suspension is to be stored and used.

However, the use of high concentration of inorganic salts in the fluidized polymer suspension is highly undesirable for some specialty applications which may include, but not limited to, washcoats, drilling fluids, specialty coatings, household products and agricultural products. It may interfere and interact with other additives such as metal particles within the formulation or, may lead to some unwanted chemical reactions with substrates, like poisoning catalytic activities or other materials/fluids it may come in contact with, during the end-user application. These inorganic salts also leave some residues on the substrates/surfaces it is coated to, and not completely removable during calcination, which is highly undesirable for specialty coating applications such as washcoats.

Hence there is a strong need exists to formulate a stable fluid suspension composition of water soluble cellulose ether polymers without using any inorganic salt based insolubilizing agents and thus eliminating the chance of any aforesaid chemical interactions during final application of aqueous based products, which contain such fluid suspension compositions.

The foregoing and other objects and features of the invention will be made apparent from the following description.

### SUMMARY OF THE INVENTION

The primary aspect of the present application is to provide an aqueous salt-free fluid suspension composition comprising: (i) about 0.01 wt. % to about 30 wt. % of at least one cellulose ether, (ii) about 0.01 wt. % to about 90 wt. % of at least one insolubilizing agent selected from the group consisting of monosaccharide, disaccharide, polysaccharide, inverted sugar, and combinations thereof, (iii) about 0.01 wt. % to about 5 wt. % of at least one stabilizing agent, (iv) about 0.01 wt. % to about 5 wt. % of at least one preservative, and (v) about 0.01 wt. % to about 70 wt. % of water.

In another aspect of the present application, the cellulose ether is selected from the group consisting of methylhydroxypropylcellulose (MHPC), hydroxypropylcellulose (HPC), methylcellulose (MC), carboxymethylcellulose (CMC), carboxymethylhydroxyethylcellulose (CMHEC), hydroxyethylcellulose (HEC), hydrophobically modified hydroxyethylcellulose (HMHEC), ethylhydroxyethylcellulose (EHEC), hydrophobically modified ethylhydroxyethylcellulose (HMEHEC), methylhydroxyethylcellulose (MHEC), and combinations thereof.

In another aspect of the present application, the methylhydroxypropylcellulose (MHPC) has a degree of polymerization (D.P.) value ranging from about 600 to about 2200 and, hydroxypropylcellulose (HPC) has a degree of polymerization (D.P.) value ranging from about 600 to about 2200.

In another aspect of the present application, the methylhydroxypropylcellulose (MHPC) has a methoxy content ranging from about 25% to about 35% and a propoxy content ranging from about 5% to about 15%.

In another aspect of the present application, the hydroxypropylcellulose (HPC) has a molar substitution (M.S.) value ranging from about 3 to about 5.

In another aspect of the present application, the monosaccharide is selected from the group consisting of glucose, dextrose, fructose, galactose, xylose, ribose, and combinations thereof; the disaccharide is selected from the group consisting of sucrose, lactose, maltose, lactulose, trehalose, and combinations thereof; and the polysaccharide is selected from the group consisting of maltodextrin, starch, amylose, amylopectin, dextran, and combinations thereof.

Another aspect of the present application discloses a process for preparing an aqueous salt-free fluid suspension composition, wherein the process comprising the steps of:
(a) adding about 0.01 wt. % to about 70 wt. % of water into a reaction container and initiating agitation;
(b) adding about 0.01 wt. % to about 5 wt. % of least one stabilizing agent into the reaction container of step (a);
(c) adding about 0.01 wt. % to about 5 wt. % of at least one preservative into the resultant of step (b);
(d) adding about 0.01 wt. % to about 90 wt. % of at least one insolubilizing agent into the resultant of step (c) and continuing the agitation to achieve complete dissolution; and,
(e) adding about 0.01 wt. % to about 30 wt. % of at least one cellulose ether into the resultant of step (d) and continuing the agitation till obtaining a homogenized fluid suspension composition.

Another aspect of the present application discloses a thickening composition comprising an aqueous salt-free fluid suspension composition comprising: (i) about 0.01 wt. % to about 30 wt. % of at least one cellulose ether, (ii) about 0.01 wt. % to about 90 wt. % of at least one insolubilizing agent selected from the group consisting of monosaccharide, disaccharide, polysaccharide, inverted sugar, and combinations thereof, (iii) about 0.01 wt. % to about 5 wt. % of at least one stabilizing agent, (iv) about 0.01 wt. % to about 5 wt. % of at least one preservative, and (v) about 0.01 wt. % to about 70 wt. % of water.

### BRIEF DESCRIPTION OF THE DRAWINGS

Illustrative embodiments of the present invention are described in detail below with reference to the attached drawing figures, which are incorporated by reference herein and wherein:

FIG. 1 illustrates the dissolution behavior of fluidized polymer suspension based on MHPC against typical dry cellulose ether powder (Natrosol 250MR HEC) suspended in an aqueous solution at pH 3 and at ambient temperature.

FIG. 2 illustrates the dissolution behavior of fluidized polymer suspension based on MHPC against typical dry cellulose ether powder (Natrosol 250MR HEC) suspended in an aqueous solution at pH 7 and at ambient temperature.

FIG. 3 illustrates the dissolution behavior of fluidized polymer suspension based on MHPC against typical dry cellulose ether powder (Natrosol 250MR HEC) suspended in an aqueous solution at pH 11 and at ambient temperature.

FIG. 4 illustrates the dissolution behavior of fluidized polymer suspension based on MHPC against typical dry cellulose ether powder (Culminal MHEC 6000PR) suspended in an aqueous solution at pH 3 and at ambient temperature.

FIG. 5 illustrates the dissolution behavior of fluidized polymer suspension based on MHPC against typical dry cellulose ether powder (Culminal MHEC 6000PR) suspended in an aqueous solution at pH 7 and at ambient temperature.

### DETAILED DESCRIPTION OF THE INVENTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in several ways. Also, it is to be understood that the phraseology and terminology employed herein is for the purpose of description and should not be regarded as limiting.

As utilized in accordance with the disclosure, the following terms, unless otherwise indicated, shall be understood to have the following meanings.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

The singular forms “a,” “an,” and “the” include plural forms unless the context clearly dictates otherwise specified or clearly implied to the contrary by the context in which the reference is made. The term “Comprising” and “Comprises of” includes the more restrictive claims such as “Consisting essentially of” and “Consisting of.”

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that may vary depending upon the desired properties to be obtained in carrying out the invention.

All percentages, parts, proportions, and ratios as used herein, are by weight of the total composition, unless otherwise specified. All such weights as they pertain to listed ingredients are based on the active level and, therefore; do not include solvents or by-products that may be included in commercially available materials, unless otherwise specified.

All publications, articles, papers, patents, patent publications, and other references cited herein are hereby incorporated herein in their entirety for all purposes to the extent consistent with the disclosure herein.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “each independently selected from the group consisting of” means when a group appears more than once in a structure, that group may be selected independently each time it appears.

The term “Inverted sugar” describes a liquified form of table sugar in which the chemical bonds between glucose and fructose molecules have been broken, produced commercially by acidic or enzymatic hydrolysis. It is resistant to crystallization and promotes retention of moisture.

In a typical definition, the “Inverted sugar” consists of “active dry substance content” hereinafter referred as “active content” and “conversion rate of the sugar” hereinafter referred as “conversion rate” hereinafter. As an example, the inverted sugar syrup 72.7/66 consists of 72.7% dry substance and 66% inverted sugar, therefore 34% saccharose.

The present disclosure is directed to an aqueous salt-free fluid suspension composition comprising: (i) about 0.01 wt. % to about 30 wt. % of at least one cellulose ether, (ii) about 0.01 wt. % to about 90 wt. % of at least one insolubilizing agent selected from the group consisting of monosaccharide, disaccharide, polysaccharide, inverted sugar, and combinations thereof, (iii) about 0.01 wt. % to about 5 wt. % of at least one stabilizing agent, (iv) about 0.01 wt. % to about 5 wt. % of at least one preservative, and (v) about 0.01 wt. % to about 70 wt. % of water.

According to one embodiment, the cellulose ether of the present invention is selected from the group consisting of methylhydroxypropylcellulose (MHPC), hydroxypropylcellulose (HPC), methylcellulose (MC), carboxymethylcellulose (CMC), carboxymethylhydroxyethylcellulose (CMHEC), hydroxyethylcellulose (HEC), hydrophobically modified hydroxyethylcellulose (HMHEC), ethylhydroxyethylcellulose (EHEC), hydrophobically modified ethylhydroxyethylcellulose (HMEHEC), methylhydroxyethylcellulose (MHEC), and combinations thereof.

According to another aspect of the invention, it is contemplated that the methylhydroxypropylcellulose (MHPC) has a degree of polymerization (D.P.) value ranging from about 600 to about 800; or from about 800 to about 1000; or from about 1000 to about 1200; or from about 1200 to about 1400; or from about 1400 to about 1600; or from about 1600 to about 1800; or from about 1800 to about 2000; or from about 2000 to about 2200.

According to another aspect of the invention, it is contemplated that the molar substitution (M.S.) of methylhydroxypropylcellulose (MHPC) comprises: a methoxy content ranging from about 25% to about 27%; or from about 27% to about 29%; or from about 29% to about 31%; or from about 31% to about 33%; or from about 33% to about 35%; and a propoxy content ranging from about 5% to about 7%; or from about 7% to about 9%; or from about 9% to about 11%; or from about 11% to about 13%; or from about 13% to about 15%.

According to another aspect, it is contemplated that the Hydroxypropylcellulose (HPC) of the present invention having a molar substitution (M.S.) value ranging from about 3 to about 3.5; or from about 3.5 to about 4; or from about 4 to about 4.5; or from about 4.5 to about 5.

According to another aspect of the invention, it is contemplated that the hydroxypropylcellulose (HPC) has a degree of polymerization (D.P.) value ranging from about 600 to about 800; or from about 800 to about 1000; or from about 1000 to about 1200; or from about 1200 to about 1400; or from about 1400 to about 1600; or from about 1600 to about 1800; or from about 1800 to about 2000; or from about 2000 to about 2200.

According to another embodiment, suitable range of cellulose ether of the present invention can be varied from about 0.01 wt. % to about 5 wt. %; or from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; based on the total weight of the fluid suspension composition.

It has been discovered that the time required for hydration and dissolution of powdered cellulosic ether polymers including, but not limited to, methylhydroxypropylcellulose (MHPC), hydroxypropylcellulose (HPC), methylcellulose (MC), carboxymethylcellulose (CMC), carboxymethylhydroxyethylcellulose (CMHEC), hydroxyethylcellulose (HEC), hydrophobically modified hydroxyethylcellulose (HMHEC), ethylhydroxyethylcellulose (EHEC), hydrophobically modified ethylhydroxyethylcellulose (HMEHEC), methylhydroxyethylcellulose (MHEC), or combinations thereof; in aqueous based formulations can be significantly reduced using fluid suspension compositions of the present invention, compared to the conventional method involving direct addition of powdered cellulosic ethers. The rapid dissolution behavior of fluid suspension compositions of the present invention versus the dry cellulosic ether powders is highly beneficial in batch processing wherein, the residence time in mixing chamber can be significantly reduced. In addition, the post addition of such powdered cellulose ether additives during intermediate processing stages is easily possible without the danger of forming lumps, flocculation, agglomeration, or other related process difficulties and handling issues.

In another embodiment of the present invention, cellulosic ether polymers that contain sufficiently high polymer solids are found useful for the preparation of fluid polymer suspensions and can be effectively formulated in to an aqueous based compositions or used for post addition during the preparation of inorganic/metal slurries or pastes. Suspensions of this type, in general, comprise at least 10% by weight, preferably 15% by weight or higher, of a cellulose ether polymer selected from, but not limited to, the group of methylhydroxypropylcellulose (MHPC), hydroxypropylcellulose (HPC), methylcellulose (MC), carboxymethylcellulose (CMC), carboxymethylhydroxyethylcellulose (CMHEC), hydroxyethylcellulose (HEC), hydrophobically modified hydroxyethylcellulose (HMHEC), ethylhydroxyethylcellulose (EHEC), hydrophobically modified ethylhydroxyethylcellulose (HMEHEC), methylhydroxyethylcellulose (MHEC), or combinations thereof; in an aqueous liquid carrier. The aqueous liquid carrier further contains dissolved or dispersed additives at sufficiently high concentrations to prevent the hydrophilic cellulose ether polymer from swelling substantially or dissolving in the aqueous medium, thus rendering it fluid, and allows the cellulose ether polymer particles to be properly dispersed and suspended, thus providing the stability. Wherever necessary, small amounts, below 0.5% by weight of preservative is added to the composition to avoid microbial degradation and particle coagulation during storage.

It is very essential to ensure sufficient means to restrict the swelling and dissolution of hydrophilic cellulose ether polymers in the aqueous medium during preparation of fluid suspension compositions. This may be achieved by introducing suitable additives that can effectively reduce the solvating power of the aqueous carrier. A conventional approach involves addition of insolubilizing agents such as inorganic salts. A wide variety of inorganic salts has been found useful for this purpose, which may typically include but not limited to, sodium chloride, potassium chloride, sodium citrate, sodium sulfate, sodium formate, potassium phosphate, calcium formate, potassium formate, sodium acetate, potassium bicarbonate, sodium bicarbonate, diammonium phosphate, ammonium sulfate, or combinations thereof. The concentration of inorganic salts must be adjusted such that the flocculation (or cloud) point, that is, the temperature at which a polymer precipitates or gels from solution to render a cloudy dispersion, is below room temperature. The concentration of inorganic salts in the fluid polymer suspension must be sufficiently high to render the polymer insoluble in the salt water at the temperature at which the fluid polymer suspension is to be stored and used. Furthermore, the inorganic salt concentration should be so high that swelling of the insolubilized polymer particles in the aqueous medium, if any, would occur only to a small degree.

However, the use of high concentration of inorganic salts in the fluidized polymer suspension is highly undesirable for some specialty applications which may include, but not limited to, washcoats, drilling fluids, specialty coatings, household products and agricultural products. It may interfere/influence with other additives such as metal particles within the formulation or, may lead to some unwanted chemical reactions with substrates or other materials/fluids it may come in contact with, during the end-user application. These inorganic salts also leave some residues on the substrates and not fully removable during calcination, which is highly undesirable for applications such as washcoats. Present invention hence contemplates the use of a salt free insolubilizing agent for the preparation of stable fluid suspension composition, highly suitable for above mentioned applications.

According to yet another embodiment, the insolubilizing agent of the present invention is selected from the group consisting of monosaccharide, disaccharide, polysaccharide, inverted sugar, and combinations thereof.

According to another embodiment, suitable monosaccharides of the present invention include, but not limited to, glucose, dextrose, fructose, galactose, xylose, ribose, and combinations thereof; suitable disaccharides of the present invention include, but not limited to, sucrose, lactose, maltose, lactulose, trehalose, and combinations thereof; and suitable polysaccharides of the present invention include, but not limited to, maltodextrin, starch, amylose, amylopectin, dextran, and combinations thereof.

In some embodiments, the insolubilizing agent of the present invention is in the form of a powder, a liquid, or an aqueous solution thereof.

In some embodiments, the insolubilizing agent of the present invention is an inverted sugar and suitable range of active content of the inverted sugar can be varied from about 65% to about 70%, or from about 70% to about 75%, or from about 75% to about 80%, or from about 80% to about 85%.

In some embodiments, the insolubilizing agent of the present invention is an inverted sugar and suitable range of conversion rate of the inverted sugar can be varied from about 55% to about 60%, or from about 60% to about 65%, or from about 65% to about 70%, or from about 70% to about 75%.

According to another embodiment, suitable range of insolubilizing agent of the present invention can be varied from about 0.01 wt. % to about 5 wt. %; or from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. %; based on the total weight of the fluid suspension composition.

According to one embodiment, the stabilizing agent of the present invention is selected from the group consisting of xanthan gum, sodium carboxymethyl cellulose, sodium alginate, bentonite clay, carrageenan, and combinations thereof.

According to another embodiment, suitable range of stabilizing agent of the present invention can be varied from about 0.01 wt. % to about 0.5 wt. %; or from about 0.5 wt. % to about 1 wt. %; or from about 1 wt. % to about 1.5 wt. %; or from about 1.5 wt. % to about 2 wt. %; or from about 2 wt. % to about 2.5 wt. %; or from about 2.5 wt. % to about 3 wt. %; or from about 3 wt. % to about 3.5 wt. %; or from about 3.5 wt. % to about 4 wt. %; or from about 4 wt. % to about 4.5 wt. %; or from about 4.5 wt. % to about 5 wt. %; based on the total weight of the fluid suspension composition.

According to one embodiment, the preservative of the present invention is selected from the group consisting of sodium benzoate, citric acid, benzyl alcohol, propylparaben, ethylparaben, butylparaben, methylparaben, benzylparaben, isobutylparaben, phenoxyethanol, ethanol, sorbic acid, benzoic acid, methylchloroisothiazolinone, methylisothiazolinone, methyl dibromoglutaronitrile, dehydroacetic acid, o-phenylphenol, 1,2-benzisothiazoline-3-one, 5-chloro-2-methyl4-isothiazoline-3-one, benzyl bromoacetate, bicyclic oxazolidines, 4,4-dimethyloxazolidine, and combinations thereof.

According to another embodiment, suitable range of preservative of the present invention can be varied from about 0.01 wt. % to about 0.5 wt. %; or from about 0.5 wt. % to about 1 wt. %; or from about 1 wt. % to about 1.5 wt. %; or from about 1.5 wt. % to about 2 wt. %; or from about 2 wt. % to about 2.5 wt. %; or from about 2.5 wt. % to about 3 wt. %; or from about 3 wt. % to about 3.5 wt. %; or from about 3.5 wt. % to about 4 wt. %; or from about 4 wt. % to about 4.5 wt. %; or from about 4.5 wt. % to about 5 wt. %; based on the total weight of the fluid suspension composition.

According to one embodiment, the present application discloses a process for preparing an aqueous salt-free fluid suspension composition, wherein the process comprising the steps of:
(a) adding about 0.01 wt. % to about 70 wt. % of water into a reaction container and initiating agitation;
(b) adding about 0.01 wt. % to about 5 wt. % of least one stabilizing agent into the reaction container of step (a);
(c) adding about 0.01 wt. % to about 5 wt. % of at least one preservative into the resultant of step (b);
(d) adding about 0.01 wt. % to about 90 wt. % of at least one insolubilizing agent into the resultant of step (c) and continuing the agitation to achieve complete dissolution; and,
(e) adding about 0.01 wt. % to about 30 wt. % of at least one cellulose ether into the resultant of step (d) and continuing the agitation till obtaining a homogenized fluid suspension composition.

The resulting polymer suspension composition of the present invention is typically fluid, pourable, and pumpable. Generally, the suspension has a viscosity of less than 20,000 mPas one day after preparation, as measured with a Brookfield Model RVT viscometer at 20 rpm/20° C. For easy pumping and mixing, a preferred product, with total polymer solids of 15% or higher, typically has a suspension viscosity of 20,000 mPas or less.

In another embodiment, the fluid suspension composition of the present invention is further formulated into an aqueous system, for e.g., washcoats, mineral, inorganic, or metal powder slurries, etc. The fluid suspension is diluted considerably, and the concentration of the additives becomes so low that the cellulose ether polymers will disperse and dissolve readily. In fact, the suspension can disperse and dissolve in aqueous media at a much higher rate than the dry polymer, since the polymer particles in the suspension have been pre-wetted and, in many cases, are slightly swollen. In other words, the instant invention allows a short mixing cycle of about 5-10 minutes rather than a 1 to 3 hour mixing period as required with convention cellulose ether polymer powder ingredients. The productivity of manufacturing aqueous systems comprising (i) aqueous salt-free fluid suspension compositions of the present invention and (ii) other additives such as, but not limited to, precious metal particles, inorganic oxides, and acids, can be significantly increased.

According to another embodiment, the fluid suspension composition of the present invention is used for preparing aqueous based formulations that find applications in products including, but not limited to washcoats, drilling fluids, concrete, joint compound, mortar, adhesives, cosmetic products, personal care products, household products, agricultural products, paints, and paper coatings.

According to one embodiment, the present application discloses a thickening composition comprising an aqueous salt-free fluid suspension composition comprising: (i) about 0.01 wt. % to about 30 wt. % of at least one cellulose ether, (ii) about 0.01 wt. % to about 90 wt. % of at least one insolubilizing agent selected from the group consisting of monosaccharide, disaccharide, polysaccharide, inverted sugar, and combinations thereof, (iii) about 0.01 wt. % to about 5 wt. % of at least one stabilizing agent, (iv) about 0.01 wt. % to about 5 wt. % of at least one preservative, and (v) about 0.01 wt. % to about 70 wt. % of water.

The thickening composition of the present application is used in washcoats, drilling fluids, concrete, joint compound, mortar, adhesives, cosmetic products, personal care products, household products, agricultural products, paints, and paper coatings.

Another embodiment of the present invention provides a process for continuous preparation of aqueous slurry compositions which may include, but not limited to, washcoats, drilling fluids, concrete, joint compound, mortar, adhesives, cosmetic products, personal care products, household products, agricultural products, paints, or paper coatings, wherein the process involves the use of an aqueous salt-free fluid suspension composition comprising: (i) about 0.01 wt. % to about 30 wt. % of at least one cellulose ether, (ii) about 0.01 wt. % to about 90 wt. % of at least one insolubilizing agent selected from the group consisting of monosaccharide, disaccharide, polysaccharide, inverted sugar, and combinations thereof, (iii) about 0.01 wt. % to about 5 wt. % of at least one stabilizing agent, (iv) about 0.01 wt. % to about 5 wt. % of at least one preservative, and (v) about 0.01 wt. % to about 70 wt. % of water. The process for producing an aqueous slurry composition further comprises addition of ingredients comprising precious metals, acids, inorganic oxides, or combinations thereof. Use of aqueous salt-free fluid suspension composition of the present invention further offers rapid viscosity adjustment and ease of handling during continuous preparation of the aqueous slurry compositions.

Another embodiment of the present invention further provides a washcoat formulation for applying a catalyst coating to a catalyst support. The support carrier is usually in the form of a honeycomb which has passages for the flow of gas. The honeycomb is used in catalytic converters for automobiles and in catalytic incinerators, which burn out pollutants in a stream of air. A typical washcoat includes alumina and also the catalyst metal, so that the catalyst coating is applied in a single step. The washcoat is intended especially for catalytic converters for automobiles or stationery.

The washcoat has a high solids content, an adjusted rheology profile, and it dries to a smooth, tightly-adhering coating without cracks. The washcoat includes the catalyst metal, such as platinum, palladium, rhodium, or other catalytic active components. The catalyst metals are dispersed on the alumina which leads to high dispersion of the metals and to high catalytic activity.

Further, certain aspects of the present application are illustrated in detail by way of the following examples. The examples are given herein for illustration of the application and are not intended to be limiting thereof.

### EXAMPLES

### Example 1: Preparation of Fluid Polymer Suspension Composition Containing Inorganic Salt

| Component | Wt. % |
|---|---|
| Purified water | 64.64 |
| Natrosol 250 MR | 20.00 |
| Ammonium sulfate (salt) | 15.00 |
| Rhodopol 23 Xanthan gum | 0.16 |
| Proxel GXL | 0.20 |
| Total | 100.00 |

Fluid suspension composition according to above formulation was prepared by mixing the ingredients in following order to obtain a 100 g sample:
1. 64.64 g of purified water was charged in a reaction container equipped with a stirrer.
2. 0.16 g of xanthan gum was then added under constant stirring and fully dissolved.
3. 0.2 g of Proxel GXL was added to the above mixture and mixed well.
4. 15 g ammonium sulfate was then added and stirred well to obtain a homogenous mixture.
5. Finally, 20 g of Natrosol 250 MR was dispersed into above mixture and stirred well to obtain a homogenous mixture.

Fluid suspension composition of Natrosol 250 MR (HEC) was prepared according to above method and evaluated its stability in aqueous systems such as washcoats. A washcoat sample was prepared using the fluid suspension composition of Example-1 and investigated towards the viscosity development over time using an Anton Paar Rheometer MCR102 at various time intervals including (i) directly after preparation, (ii) after 3 days and (iii) after 5 days. It was observed that the fluid suspension composition of example-1 showed unpredictable thickening behavior when interacted with the washcoat components. Due to the extreme low pH and catalytic components, the HEC (Natrosol 250 MR) of above formulation caused to react in a non-predictive way and failed to quickly provide a stable rheology value.

### Example 2: Reducing/Eliminating the Inorganic Salt Content of Fluid Polymer Suspension

Various fluid suspension compositions of Culminal MHPC 814 (MHPC) of higher purity non-glyoxal treated finer milling grade were prepared according to below method. In this approach, amount of Ammonium sulfate salt has been significantly reduced to 5 wt. % by incorporating various saccharides according to Table-1.

Fluid suspension compositions according to Examples 2(a)-2(k) of Table-1 were prepared by mixing the ingredients in following order to obtain a 100 g sample:
1. 37.40 g to 54.80 g of purified water according to table-1 was charged in a reaction container equipped with a stirrer.
2. 0.1 g of xanthan gum was then added under constant stirring and fully dissolved.
3. 0.1 g Proxel GXL was added to the above mixture and mixed well.
4. 5 g ammonium sulfate was added and stirred well to obtain a homogenous mixture.
5. 20 g-37.4 g of an insolubilizing agent (saccharides or inverted sugars) according to Table-1 was added to above mixture and dissolved well.
6. Finally, 20 g of Culminal MHPC 814 was dispersed into above mixture and stirred well to obtain a homogenous mixture.

After preparation, the flow behavior and foaming behavior of the slurry were evaluated. Aim was to generate a free flowing liquid suspension. The prepared suspensions were individually taken in a 100 ml graded cylinder and sealed. The amount of syneresis of each sample was observed over a period of 2 months and recorded.

TABLE 1

| | Ex. | Ex. | Ex. | Ex | Ex. | Ex. | Ex. | Ex. | Ex. | Ex. | Ex. |
|---|---|---|---|---|---|---|---|---|---|---|---|
| | 2(a) | 2(b) | 2(c) | 2(d) | 2(e) | 2(f) | 2(g) | 2(h) | 2(i) | 2(j) | 2(k) |
| Components | Wt. % | Wt. % | Wt. % | Wt. % | Wt. % | Wt. % | Wt. % | Wt. % | Wt. % | Wt. % | Wt. % |
| Purified water | 44.8 | 44.8 | 44.8 | 44.8 | 54.80 | 37.40 | 37.40 | 44.8 | 44.8 | 44.8 | 44.8 |
| Culminal MHPC 814 | 20.00 | 20.00 | 20.00 | 20.00 | 20.00 | 20.00 | 20.00 | 20.00 | 20.00 | 20.00 | 20.00 |
| Ammonium sulfate | 5.00 | 5.00 | 5.00 | 5.00 | 5.00 | 5.00 | 5.00 | 5.00 | 5.00 | 5.00 | 5.00 |
| Saccharose (table sugar) | 30.00 | — | — | — | — | — | — | — | — | — | — |
| D-Lactose monohydrate | — | 30.00 | — | — | — | — | — | — | — | — | — |
| Myo-Inositol | — | — | 30.00 | — | — | — | — | — | — | — | — |
| Maltodextrin | — | — | — | 30.00 | — | — | — | — | — | — | — |
| Sorbitol | — | — | — | — | 20 | — | — | — | — | — | — |
| Glucose syrup 45° | — | — | — | — | — | 37.40 | — | — | — | — | — |
| Glucose syrup 43° | — | — | — | — | — | — | 37.40 | — | — | — | — |
| Inverted sugar syrup | — | — | — | — | — | — | — | 30.00 | — | — | — |
| 81/55 | | | | | | | | | | | |
| Inverted sugar syrup | — | — | — | — | — | — | — | — | 30.00 | — | — |
| 80/95 | | | | | | | | | | | |
| Inverted sugar syrup | — | — | — | — | — | — | — | — | — | 30.00 | — |
| 75.0/66 | | | | | | | | | | | |
| Inverted sugar syrup | — | — | — | — | — | — | — | — | — | — | 30.00 |
| 72.7/66 | | | | | | | | | | | |
| Rhodopol 23 Xanthan | 0.10 | 0.10 | 0.10 | 0.10 | 0.10 | 0.10 | 0.10 | 0.10 | 0.10 | 0.10 | 0.10 |
| gum | | | | | | | | | | | |
| Proxel GXL | 0.10 | 0.10 | 0.10 | 0.10 | 0.10 | 0.10 | 0.10 | 0.10 | 0.10 | 0.10 | 0.10 |
| Total | 100.00 | 100.00 | 100.00 | 100.00 | 100.00 | 100.00 | 100.00 | 100.00 | 100.00 | 100.00 | 100.00 |

### Results and Observations:

Ex. 2(a): Difficult to dissolve the desired amounts and showed problems due to crystallization.
Ex. 2(b): Unable to dissolve the desired amount into water.
Ex. 2(c): Unable to dissolve the desired amount into water.
Ex. 2(d): Good solubility, but still on its own not good enough to fully reduce the salt content.
Ex. 2(e): good solubility, but still on its own not good enough to fully reduce the salt content.
Ex. 2(f): Very thick and needed to be diluted with water 50:50.
Ex. 2(g): Thinner than the 45° and therefore better handling, but still too thick.
Ex. 2(h): Based on the product data clearly too thick to be handled.
Ex. 2(i): Based on the product data clearly too thick to be handled.
Ex. 2(j): Thinner than Inverted sugar syrup of Ex. 2(i).
Ex. 2(k): As this sugar solution was the thinnest, we have been able to disperse directly the Culminal MHPC 814.

### Example 3: Two-Component Fluid Suspension Formulation

| Component | Wt. % |
|---|---|
| Inverted sugar 72.7/66 | 80.00 |
| Culminal MHPC 814 | 20.00 |
| Total | 100.00 |

Fluid suspension composition according to above formulation was prepared by mixing the ingredients in following order to obtain a 100 g sample:
1. 80 g of inverted sugar 72.7/66 was taken in a reaction container equipped with a stirrer.
2. 20 g of Culminal MHPC 814 was then added under rigorous stirring until a smooth suspension was obtained.

A two-component fluid suspension composition was prepared and tested for the stability. Three 100 ml plastic beakers equipped with screw cap were filled with 100 ml of the final FPS formulation. One beaker was stored in the fridge, one beaker was stored at room temperature and one beaker in a heating chamber at 40° C. All samples were stored for one month at the mentioned conditions and were regularly checked for separation or other changes. It found stable for over a month without any degradation or mold growth however, the composition showed a little syneresis during storage.

### Example 4: Preparation of Stable Fluid Suspension Composition

| Component | Wt. % |
|---|---|
| Purified water | 19.70 |
| Inverted sugar 72.7/66 | 60.00 |
| Culminal MHPC 814 | 20.00 |
| Rhodopol 23 Xanthan gum | 0.10 |
| Sodium benzoate | 0.10 |
| Citric acid | 0.10 |
| Total | 100.00 |

Fluid suspension composition according to above formulation was prepared by mixing the ingredients in following order to obtain a 100 g sample:
1. 19.7 g of purified water was charged in a reaction container equipped with an impeller stirrer.
2. 0.1 g of xanthan gum was then added to the mixture and completely dissolved.
3. 0.1 g of sodium benzoate was added and allowed to dissolve and subsequently convert into benzoic acid in acidic environment.
4.0.1 g of citric acid was then added to achieve a pH of 5.
5.60 g of inverted sugar 72.7/66 was then added and dissolved well.
6. Finally, 20 g of Culminal MHPC 814 powder was incorporated into the mixture slowly to avoid entrapping air.

A fluid suspension composition was prepared and tested for the stability. Three 100 ml plastic beaker equipped with screw cap were filled with 100 ml of the final FPS formulation. One beaker was stored in the fridge, one beaker was stored at room temperature and one in a heating chamber at 40° C. All samples were stored for one month at the mentioned conditions and were regularly checked for separation or other changes. None of the samples showed any deviation during the one-month period. The composition showed better stability on storage.

### Example 5: Trials with Other Cellulose Ethers

Method of preparation: Fluid suspension compositions of Example 5(a)-5(c) according to Table-2 were prepared by mixing the ingredients in following order to obtain a 100 g sample:
1. 19.7 g of purified water was charged in a reaction container equipped with an impeller stirrer.
2. 0.1 g of xanthan gum was then added to the mixture and completely dissolved.
3. 0.1 g of sodium benzoate was added and allowed to dissolve and subsequently convert into benzoic acid in acidic environment.
4. 0.1 g of citric acid was then added to achieve a pH of 5.
5. 60 g-65 g of inverted sugar 72.7/66 according to Table 2 was added and dissolved well.
6. Finally, 15 g-20 g of cellulose ether powder (for e.g., Benecel E10M, Culminal MHPC 724, or Klucel HXF) according to Table 2 was incorporated into the mixture slowly to avoid entrapping air.

Fluid suspension compositions of Benecel E10M, Culminal MHPC 724, and Klucel HXF were obtained according to above method. After preparation, the fluidized polymer suspension composition samples were investigated towards the flow behavior by pouring it out of the preparation vessel into a graded cylinder. The visual inspection gave insight onto homogeneity and viscosity. The graduated cylinder was sealed with a cling foil and put aside to check for separation and stability for one week.

TABLE 2

| | Example | Example | Example |
|---|---|---|---|
| | 5(a) | 5(b) | 5(c) |
| Component | wt. % | wt. % | wt. % |
| Purified water | 19.70 | 19.70 | 19.70 |
| Inverted sugar 72.7/66 | 60.00 | 60.00 | 65.00 |
| Benecel E10M (HPMC) | 20.00 | — | — |
| Culminal MHPC 724 | — | 20.00 | — |
| Klucel HXF (HPC) | — | — | 15.00 |
| Rhodopol 23 (Xanthan gum) | 0.10 | 0.10 | 0.10 |
| Sodium benzoate | 0.10 | 0.10 | 0.10 |
| Citric acid | 0.10 | 0.10 | 0.10 |
| Total | 100.00 | 100.00 | 100.00 |

### Results and Observations:

Example 5(a): works, stable, but a little thicker than Example 4
Example 5(b): works, stable, thicker than Example 4, thinner than Example 5(a)
Example 5(c): works, stable, but a little thicker than Example 4

### Example 6: Dissolution Behavior

Dissolution behavior of fluidized polymer suspension based on MHPC and typical dry cellulose ether powders such as (i) Natrosol 250MR HEC, and (ii) Culminal MHEC 6000PR, suspended in an aqueous solution at ambient temperature and at varying pH levels (pH 3, pH 7 and pH 11) were measured. Brookfield R/S+ rheometer using V80/40 vane spindle at 400 rpm was used to measure the torque development over time. All viscosity values were normalized towards a percentage scale to have the direct comparison of the viscosity development.

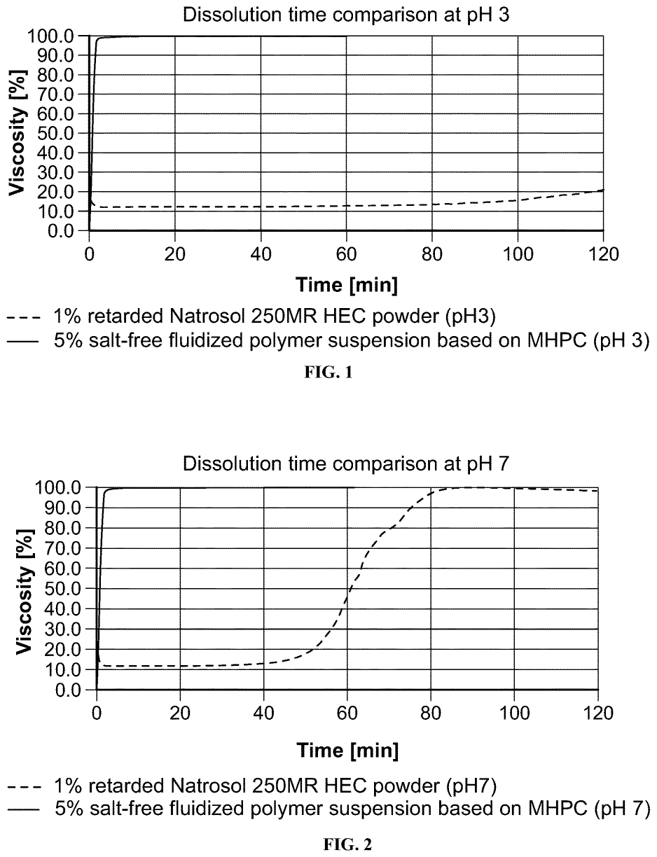

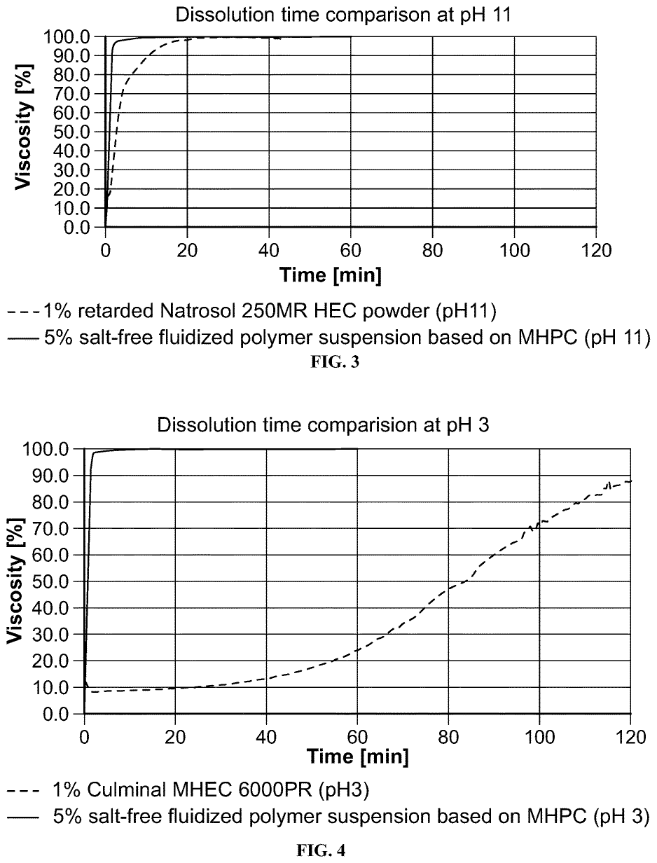

FIG. 1-3 illustrate the dissolution behavior as an indicative of dissolution time measured at various pH levels such as pH 3, pH 7 and pH 11 for a fluidized polymer suspension based on MHPC relative to a typical dry cellulose ether powder (Natrosol 250MR HEC) suspended in an aqueous solution at ambient temperature. The magnitude of increase in dissolution rate with the fluid polymer suspension composition is striking. It takes a typical fluid polymer suspension composition less than five minutes to develop more than 95% of the ultimate solution viscosity, while the conventional dry polymer powder takes more than 40 minutes under the same conditions.

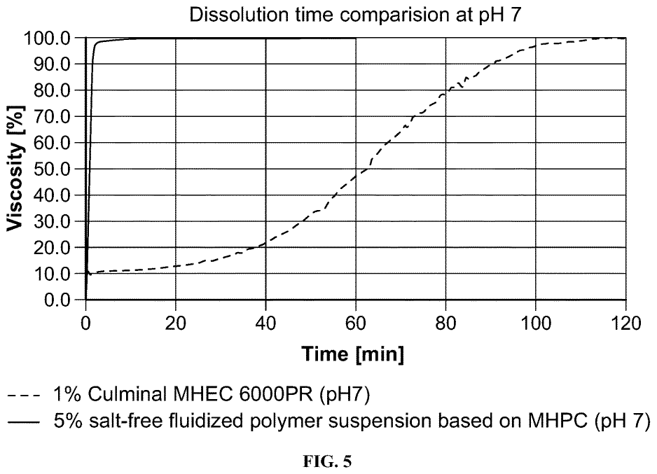

Similarly, FIG. 4-5 illustrate the dissolution behavior as an indicative of dissolution time measured at various pH levels such as pH 3, pH 7 for a fluidized polymer suspension based on MHPC relative to a typical dry cellulose ether powder (Culminal MHEC 6000PR) suspended in an aqueous solution at ambient temperature. The magnitude of increase in dissolution rate with the fluid polymer suspension composition is striking in this example as well. It takes a typical fluid polymer suspension composition less than five minutes to develop more than 95% of the ultimate solution viscosity, while the conventional dry polymer powder takes more than 100 minutes under the same conditions.

Therefore, dusting and particle lumping, two common problems in solution preparation of the conventional dry polymer powder additives are completely eliminated with the use of the fluid polymer suspension compositions described by the present invention.

What is claimed is:

1. An aqueous salt-free fluid suspension composition comprising:
i) about 0.01 wt. % to about 30 wt. % of at least one cellulose ether;
ii) about 0.01 wt. % to about 90 wt. % of at least one insolubilizing agent selected from the group consisting of monosaccharide, disaccharide, polysaccharide, inverted sugar, and combinations thereof;
iii) about 0.01 wt. % to about 5 wt. % of at least one stabilizing agent;
iv) about 0.01 wt. % to about 5 wt. % of at least one preservative; and,
v) about 0.01 wt. % to about 70 wt. % of water.

2. The composition according to claim 1, wherein the cellulose ether is selected from the group consisting of methylhydroxypropylcellulose (MHPC), hydroxypropylcellulose (HPC), methylcellulose (MC), carboxymethylcellulose (CMC), carboxymethylhydroxyethylcellulose (CMHEC), hydroxyethylcellulose (HEC), hydrophobically modified hydroxyethylcellulose (HMHEC), ethylhydroxyethylcellulose (EHEC), hydrophobically modified ethylhydroxyethylcellulose (HMEHEC), methylhydroxyethylcellulose (MHEC), and combinations thereof.

3. The composition according to claim 1, wherein the cellulose ether is selected from the group consisting of methylhydroxypropylcellulose (MHPC), hydroxypropylcellulose (HPC), and combinations thereof.

4. The composition according to claim 3, wherein the methylhydroxypropylcellulose (MHPC) has a degree of polymerization (D.P.) value ranging from about 600 to about 2200.

5. The composition according to claim 3, wherein the hydroxypropylcellulose (HPC) has a degree of polymerization (D.P.) value ranging from about 600 to about 2200.

6. The composition according to claim 3, wherein the methylhydroxypropylcellulose (MHPC) has a methoxy content ranging from about 25% to about 35% and a propoxy content ranging from about 5% to about 15%.

7. The composition according to claim 3, wherein the hydroxypropylcellulose (HPC) has a molar substitution (M.S.) value ranging from about 3 to about 5.

8. The composition according to claim 1, wherein the amount of cellulose ether ranges from about 1 wt. % to about 25 wt. %.

9. The composition according to claim 1, wherein the insolubilizing agent is in the form of powder, liquid, or aqueous solution.

10. The composition according to claim 1, wherein the monosaccharide is selected from the group consisting of glucose, dextrose, fructose, galactose, xylose, ribose, and combinations thereof.

11. The composition according to claim 1, wherein the disaccharide is selected from the group consisting of sucrose, lactose, maltose, lactulose, trehalose, and combinations thereof.

12. The composition according to claim 1, wherein the polysaccharide is selected from the group consisting of maltodextrin, starch, amylose, amylopectin, dextran, and combinations thereof.

13. The composition according to claim 1, wherein the inverted sugar has an active content of about 65% to about 85% and a conversion rate of about 55% to about 75%.

14. The composition according to claim 1, wherein the inverted sugar has an active content of about 70% to about 80% and a conversion rate of about 60% to about 70%.

15. The composition according to claim 1, wherein the amount of insolubilizing agent ranges from about 40 wt. % to about 85 wt. %.

16. The composition according to claim 1, wherein the stabilizing agent is selected from the group consisting of xanthan gum, sodium carboxymethyl cellulose, sodium alginate, bentonite clay, carrageenan, and combinations thereof.

17. The composition according to claim 1, wherein the stabilizing agent is xanthan gum.

18. The composition according to claim 1, wherein the amount of stabilizing agent ranges from about 0.01 wt. % to about 2 wt. %.

19. The composition according to claim 1, wherein the preservative is selected from the group consisting of sodium benzoate, citric acid, benzyl alcohol, propylparaben, ethylparaben, butylparaben, methylparaben, benzylparaben, isobutylparaben, phenoxyethanol, ethanol, sorbic acid, benzoic acid, methylchloroisothiazolinone, methylisothiazolinone, methyl dibromoglutaronitrile, dehydroacetic acid, o-phenylphenol, 1,2-benzisothiazoline-3-one, 5-chloro-2-methyl4-isothiazoline-3-one, benzyl bromoacetate, bicyclic oxazolidines, 4,4-dimethyloxazolidine, and combinations thereof.

20. The composition according to claim 1, wherein the preservative is selected from the group consisting of sodium benzoate, citric acid, and combinations thereof.

21. The composition according to claim 1, wherein the amount of preservative ranges from about 0.01 wt. % to about 2 wt. %.

22. The composition according to claim 1 is used in washcoats, drilling fluids, concrete, joint compound, mortar, adhesives, cosmetic products, personal care products, household products, agricultural products, paints, and paper coatings.

23. A process for preparing an aqueous salt-free fluid suspension composition comprising the steps of:
(a) adding about 0.01 wt. % to about 70 wt. % of water into a reaction container and initiating agitation;
(b) adding about 0.01 wt. % to about 5 wt. % of least one stabilizing agent into the reaction container of step (a);
(c) adding about 0.01 wt. % to about 5 wt. % of at least one preservative into the resultant of step (b);
(d) adding about 0.01 wt. % to about 90 wt. % of at least one insolubilizing agent into the resultant of step (c) and continuing the agitation to achieve complete dissolution; and,
(e) adding about 0.01 wt. % to about 30 wt. % of at least one cellulose ether into the resultant of step (d) and continuing the agitation till obtaining a homogenized fluid suspension composition.

24. The process according to claim 23, wherein the preservative or the preservative system is selected from the group consisting of sodium benzoate, citric acid, benzyl alcohol, propylparaben, ethylparaben, butylparaben, methylparaben, benzylparaben, isobutylparaben, phenoxyethanol, ethanol, sorbic acid, benzoic acid, methylchloroisothiazolinone, methylisothiazolinone, methyl dibromoglutaronitrile, dehydroacetic acid, o-phenylphenol, 1,2-benzisothiazoline-3-one, 5-chloro-2-methyl4-isothiazoline-3-one, benzyl bromoacetate, bicyclic oxazolidines, 4,4-dimethyloxazolidine, and combinations thereof.

25. The process according to claim 23, wherein the stabilizing agent is selected from the group consisting of xanthan gum, sodium carboxymethyl cellulose, sodium alginate, bentonite clay, carrageenan, and combinations thereof.

26. The process according to claim 23, wherein the insolubilizing agent is selected from the group consisting of monosaccharide, disaccharide, polysaccharide, inverted sugar, and combinations thereof;

27. The process according to claim 23, wherein the cellulose ether is selected from the group consisting of methylhydroxypropylcellulose (MHPC), hydroxypropylcellulose (HPC), methylcellulose (MC), carboxymethylcellulose (CMC), carboxymethylhydroxyethylcellulose (CMHEC), hydroxyethylcellulose (HEC), hydrophobically modified hydroxyethylcellulose (HMHEC), ethylhydroxyethylcellulose (EHEC), hydrophobically modified ethylhydroxyethylcellulose (HMEHEC), methylhydroxyethylcellulose (MHEC), and combinations thereof.

28. A thickening composition comprising an aqueous salt-free fluid suspension composition of claim 1.

29. The composition according to claim 28, wherein the thickening composition is used in washcoats, drilling fluids, concrete, joint compound, mortar, adhesives, cosmetic products, personal care products, household products, agricultural products, paints, and paper coatings.

30. The composition according to claim 29, wherein the thickening composition is used in the range of from about 1 wt. % to about 30 wt. %.
